(19) United States
(12) Patent Application Publication
(10) Pub. No.: US 2011/0025465 A1
(43) Pub. Date: Feb. 3, 2011

(54) WIRELESS INFORMATION CARRIER

(76) Inventor: Ole Danekilde, Oelsted (DK)

Correspondence Address: HARNESS, DICKEY & PIERCE, P.L.C., P.O. BOX 8910, RESTON, VA, 20195, US

(21) Appl. No.: 12/736,434

(22) PCT Filed: Apr. 16, 2008
(86) PCT No.: PCT/EP2008/054569

§ 371 Date: Oct. 7, 2010

(51) Int. Cl. H04Q 5/22; G06K 19/077; H02J 17/00; H05K 7/14

(52) U.S. Cl. 340/10.1; 235/492; 307/104; 211/26

(57) ABSTRACT

Communication between RFID tags and RFID reader conveyed by an inductive link comprising a first (114, 212, 324) and a second coil (118, 216, 328) interconnected by a pair of conductors (116, 326) characterised in that the first coil (114, 212, 324) is configured to interact electromagnetically with a communication unit (110, 210, 320) and the second coil (118, 216, 328) is configured to interact electromagnetically with a wireless memory unit (122, 316). The inductive link may be realised as conducting wires or as cut-outs of metal plate, and possibly employed for specifically accessing individual RFID tags by using a switching means, and employed in a system for identification and organisation of laboratory samples.

The present invention relates to the technical field of reading and writing information to a wireless memory unit such as a RFID tag.

Radio Frequency Identification (RFID) tags have become a widely used technology for storing information about a wide range of objects. An RFID tag typically works by radio communication with a transceiver unit often called an RFID reader which is equipped with an antenna for reading and writing information into the tag. Currently ISO standards for RFID communication exists for frequencies ranging from 135 kHz to 2.45 GHz, but the present invention is also applicable for even higher radio frequencies. In many cases the information is written to the RFID tag under circumstances without a need for information about the position of the RFID tag. In other cases however, the relative position of the RFID tag and the RFID reader is important; either because the information in the RFID tag and the position of the RFID tag are related, or because the RFID tag and the related object has a position which makes radio communication difficult in all but one or a few positions. Examples of difficult communication with an RFID tag are the cases where the physical space around the object to be identified is limited or where several objects to be identified are positioned physically close to each other, with the risk of identifying the wrong object. One solution for the problems related to specific communication is the use of a highly directional antenna—but the use of such an antenna has the drawback that it will take up extra space, and thus extra costs will be involved in its implementation.

A specific case where these problems may be observed is in the case of laboratory samples positioned in a sample organiser such as a linear rack on a linear conveyor, or a rectangular tray with a two dimensional array of samples. For identification of such samples it is desirable to either mount an RFID tag on the sample container; as an integral part of the sample container, often as part of the sample containers base; or place the RFID tag in the sample. For identification of laboratory samples it is desirable to communicate with the RFID tag at the time where a sample is taken from the sample container, or shortly after. The benefit of this is that a sample may be identified simultaneously with analysis, or alternatively if communication is made shortly after analysis that a result may be stored in the RFID tag associated with a sample. For this reason the desired position of a reader will be under the sample in the position where the sample is taken from the test bottle, or possibly next to this sample. However a type of sample organisers often used, is a rack made of metal which will shield the RFID tag from the antenna, and furthermore the base of a conveyor is often made of metal and may contain the electronics and other hardware necessary for controlling and driving the conveyor. For this reason the reader position under the sample container is often not feasable, and the alternative position on the side of the conveyor is used, which increases the risk of identifying the wrong object. For rectangular trays especially the reading of samples in the interior of the tray is challenging, but may be solved by movement of the RFID reader or of the tray of samples. Such a solution would, however, introduce extra complexity by additional moving parts.

The present invention is intended to alleviate some or all of the problems described above.

As an alternative to the transmission of data by a directional antenna, communication between RFID transceiver and the RFID tag is established by using an inductively coupled link. In this case a coil coupling efficiently with the RFID reader may be placed close to the RFID reader and linked by a pair of conducting wires to a coil placed close to an RFID tag. The radio frequency signal induced in the respective coils may in this way be directed between the RFID reader antenna and the RFID tag antenna irrespectively of their physical location.

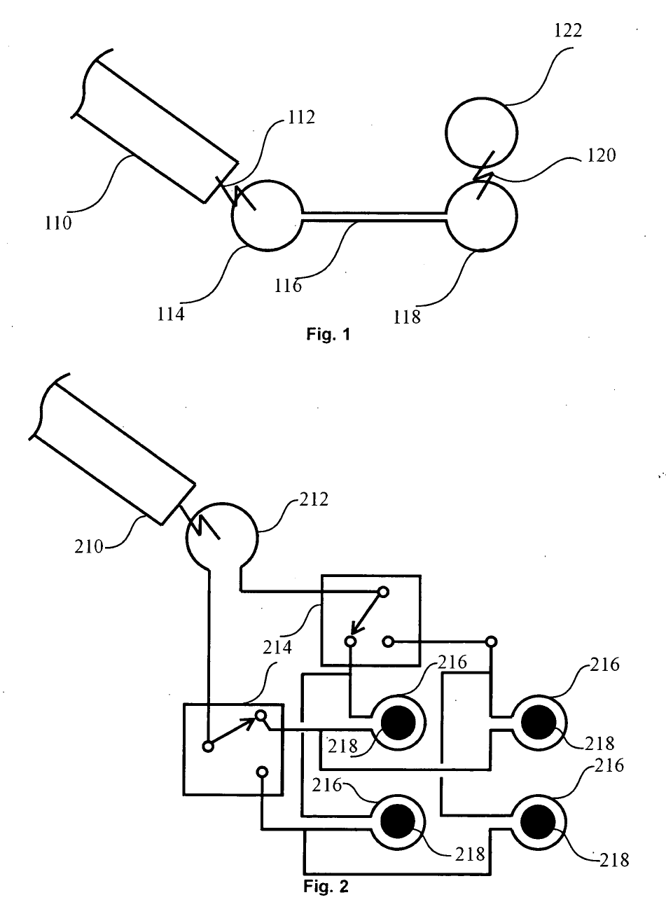

FIG. 1 conceptually shows the use of an inductively coupled link for communication between a RFID transceiver and a RFID tag.

FIG. 2 shows the use of an inductively coupled link in communication with RFID tags in objects organised in a rectangular organiser.

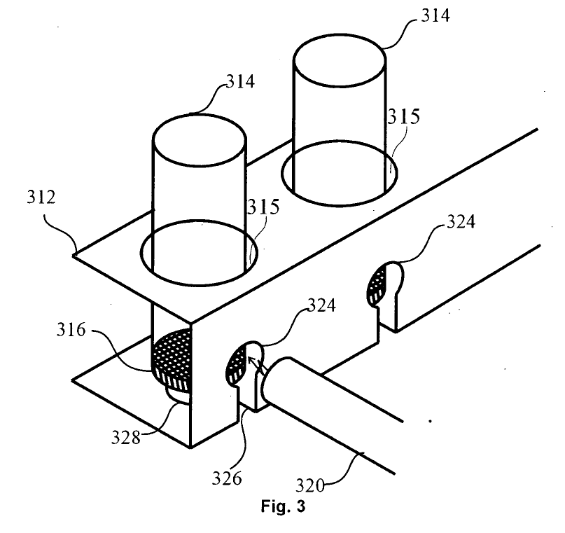

FIG. 3 shows an organiser of objects and

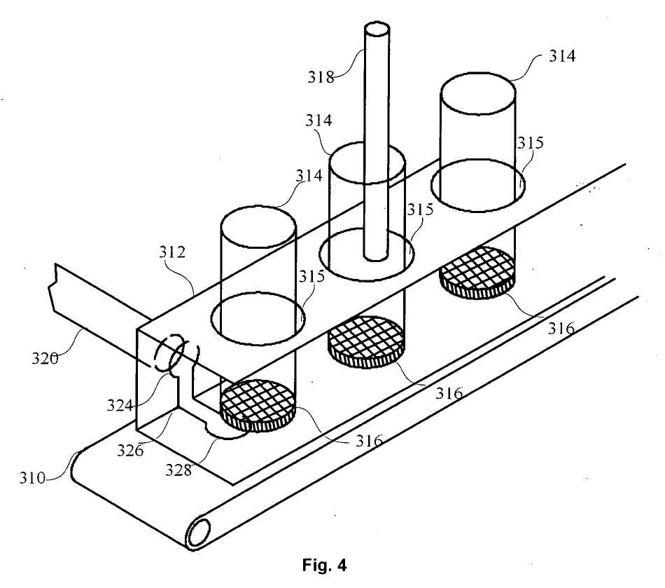

FIG. 4 illustrates a system for analysis of samples, employing a metal sample organiser as an inductively coupled link.

An exemplary embodiment of the invention is shown in FIG. 1, where a system for communication between a communication unit 110 and a wireless memory unit 122 is disclosed. In this embodiment a communication unit 110, such as an RFID reader, is placed in proximity to a coil of conducting material 114, which together with a pair of conductors 116 and a second coil 118 constitute an inductively coupled link. The second coil 118 is placed in proximity to a RF wireless memory unit 122 such as a RFID tag, comprising sub-units for radio communication and memory storage, and possibly also sub-units for data processing, said units may be of the passive type, powered from inducted current or of the active type, powered from a built in power source. The invention may operate in one or both of a read mode and a write mode, as described below. In write mode the communication unit 110 receives information which is to be transferred to the wireless memory unit 122. The communication unit 110 translates the information to be transferred to the wireless memory unit 122 to a radio signal 112 by an appropriate protocol and transmits the signal 112, which is received by the first coil 114, and conveyed by the pair of conductors 116 to the second coil 118, from where a radio signal 120 is transmitted to the wireless memory unit 122, in which the signal is decoded and processed and/or stored according to the protocol of communication. In read mode the communication unit 110 transmits a radio signal which according to the protocol used requests information from the memory unit 122. The signal is thus conveyed via the inductively coupled link to the wireless memory unit 122, which subsequently transmits a radio signal 120 coded to communicate the appropriate information, according to the protocol of communication. The signal 120 transmitted from the wireless memory unit 122 is received by the second coil 118, conveyed via the conducting wires 116 and transmitted from the first coil 114 to be received by the communication unit 110; meaning that in read mode the inductively coupled link conveys a radio signal 120 from the memory unit 122 to the communication unit 110.

A second exemplary embodiment is shown in FIG. 2. This embodiment combines the transmission of radio frequency information via an inductively coupled link, with a device for organising a number of objects in a multidimensional array, such as sample containers in a rectangular sample organizer tray. A first coil 212 is positioned in proximity to a communication unit 210 and a number of second coils 216 in proximity to the sample container positions. A switching means 214 such as mechanically or electronically controlled switches is set to define the electrical connection between said first coil 212 and one or more specific second coils 216. In this way, the communication unit 210 may be switched to communicate with one or more specific wireless memory units 218 in one or more specific positions in the organizer, which are associated with specific sample containers, without physical movement of the organiser or the reader.

A specific embodiment is the reading, prior to analysis, of a sample identification from the wireless memory unit 218 associated with a specific sample container position, and the subsequent writing of analytical result in the wireless memory unit 218 after analysis. In this case the sequence of operation is that the switching means 214 are configured for communication between the communication unit 210 and a specific second coil 214 associated with the sample container containing the sample to be analysed. The sample identification is then read from the wireless memory unit 218 by the communication unit 210, via the link comprising the first coil 212, the switching means 214, and the second coil 216. After this analysis is made and the analytical result may then be stored in the wireless memory unit 218 by a write process of the communication unit 210, via the link comprising the first coil 212, the switching means 214, and the second coil 216.

In the illustration of this embodiment a coil is used for establishing an inductive link 212 between the communication unit 210 and the switching means 214. However this connection may also be established directly, by connecting the radio frequency circuit of the communication unit 210 to the switching means 214, possibly requiring an appropriate matching of inductance, by means suchs as a transformer.

Especially in the realisation of the embodiments involving switching means 214, due care must be taken to follow good practices for radio frequency communication, including appropriate lay-out and dimensioning of circuits, shielding from noise and matching of inductances.

FIG. 3 shows a third exemplary embodiment, which is a system for communication between a wireless communication unit 320 and a wireless memory unit 316 associated with a sample container 314, utilising the fact that high frequency signals are conducted on the surface of metal sheets. Therefore the edges of a metal object may be considered equivalent to a conductor and the bulk metal sheet equivalent an isolator. Accordingly an equivalent to the inductively coupled link of the first exemplary embodiment may be made by appropriate cutouts in the metal of the organiser, as described below. Said system comprises an organiser 312 made of metal, with a number of placeholders 315; a wireless communication unit 320 and one or more objects such as sample containers 314. Each placeholder 315 has an associated individual memory unit 316 which, in the present embodiment is collocated with a sample container 314 located in the respective placeholder 315. The organiser 312 may, as in the present embodiment, be a rack for organising laboratory sample containers 314. This rack 312 may be formed from a folded a metal sheet with appropriate placeholder 315 and circular coil cut-outs 324, 328 as shown in FIG. 3. The first circular cutout 324 and the second circular cutout 328 will be equivalent to the first 114 and second 118 single-winding coil in the first embodiment; and the two edges of a linear cutout 326 will be equivalent to the pair of conductors 116. The organiser 312 will preferably have several such coupled links, one for each placeholder 315, allowing specific communication with the wireless memory unit 316 collocated with each object 314.

A fourth exemplary embodiment is illustrated in FIG. 4. This embodiment is a system for analysis which employs the type of coupled link, described in the third embodiment. The system comprises a conveyor 310 for moving an organiser 312 of a multitude of sample containers 314 of which all or some may have wireless memory units 316 collocated therewith, for example connected to or integrated in the sample container 314, a communication unit 320 for reading and/or writing information and an analytical device 318 for analysing said sample, either by extracting an aliquot of said sample or by subjecting said sample as a whole to analysis. Information regarding the sample may then be read from or written to said wireless memory unit 316 when the sample is in a known position as required by the analytical device 318.

In this embodiment a communication device 320 is placed in proximity to a first cut-out 324 which will receive radio communication signals and convey this via conducting edges 326 to a second cut-out 328 transmitting radio communication signals to be received by a wireless memory unit 316 such as a RFID tag. The possible modes of communication will be similar to those of the first embodiment. As shown in FIG. 3 the sample container 314 positioned next to the analytical device 318 is connected to the communication unit 320 by an inductively coupled link. This ensures that communication will always be with the wireless memory unit 316 associated with the sample container 314 containing the sample most recently analysed.

The optimal physical dimensions of the coils will be dictated by the requirement of an overlap of electromagnetic fields, and therefore be defined by the frequency of radio communication as well as the dimensions of the built in antenna coils in the RFID tag and the RFID reader. For a typical RFID tag operating at a frequency of 13.5 MHz the preferred dimensions of the coils will be 10-30 mm, but provided the size of the antenna coils of RFID tag and RFID reader were larger, an increased size is possible. A decrease in size will be limited by the self inductance of the circuit and accordingly the invention will require larger coils to be compatible with 125 kHz RFID systems.

1-8. (canceled)

9. An inductive link made from a metal plate comprising a first cut-out and a second cut-out interconnected by a slit characterised in that the first cut-out is configured to interact by radio communication with a communication unit and the second cut-out is configured to interact by radio communication with a wireless memory unit.

10. An organiser having one or more holding positions characterised in that each holding position is specifically associated with a second cut-out of an inductive link according to claim 9.

11. An organiser according to claim 10 wherein said holding positions are adapted to receive sample containers for samples to be analysed.

12. A system comprising a communication unit, a wireless memory unit and an inductive link characterised in that said inductive link is one according to claim 9.

13. A system comprising a communication unit, an organiser comprising one or more holding positions for objects each associated with an own wireless memory unit, characterised in that radio communication between said communication unit and said wireless memory units is conveyed by corresponding inductive links according to claim 9.
